(19) United States
(12) Patent Application Publication
(10) Pub. No.: US 2015/0353771 A1
(43) Pub. Date: Dec. 10, 2015

(54) COATING COMPOSITIONS WITH AN AQUEOUS DISPERSION CONTAINING A POLYURETHANE AND AN ACID REACTIVE CROSSLINKING AGENT

(71) Applicant: Bayer MaterialScience LLC, Pittsburgh, PA (US)

(72) Inventor: Margaret A. Kendi, Coraopolis, PA (US)

(73) Assignee: Bayer MaterialScience LLC

(21) Appl. No.: 14/300,382

(22) Filed: Jun. 10, 2014

(51) Int. Cl. C09D 175/12

(52) U.S. Cl. CPC C09D 175/12

(57) ABSTRACT

Disclosed are coating compositions that include an aqueous dispersion that includes an aliphatic, fatty-acid containing, anionic polyurethane and an acid-reactive crosslinking agent. Also disclosed are uses of such coating compositions, such as in the coating of plastic, such as vinyl substrates.

### FIELD

The present invention relates to coating compositions. The coating compositions comprise: (A) an aqueous dispersion comprising: (i) an aliphatic, acid-containing, anionic polyurethane; and (ii) an acid-reactive crosslinking agent; and (B) a coalescing agent. The present invention also relates to uses of such coating compositions, in the coating of, for example, plastic, such as vinyl, substrates, such as may be in the form of a frame of an architectural article, such as a window frame.

### BACKGROUND INFORMATION

Polyurethane coatings are used in many applications because they exhibit many advantageous properties. In some cases, often for environmental reasons, such polyurethane coatings are formed from aqueous compositions rather than organic solvent-borne compositions. Some of these aqueous compositions include a polyurethane dispersion in which the polyurethane has crosslinkable groups that are capable of reacting with a crosslinking agent.

Over the last several years, there has been an increase in demand for window frames, such as those constructed of polymeric materials, such as polyvinyl chloride (“PVC”), that are coated in order to, for example, provide window frames having a customized color. Such coatings often are expected to meet stringent performance requirements, such as those set forth in American Architectural Manufacturers Association (“AAMA”) specification 615-05, entitled Performance Requirements and Test Procedures for Superior Performing Organic Coatings on Plastic Profiles. Moreover, for convenience, coating compositions formulated as a single-component composition (in which all of the composition components are stored together in a single container) are often desired, provided the composition has a long pot life and, when deposited over a substrate, forms a coating exhibiting such properties when allowed to cure at ambient temperature conditions, below 30° C.

The present invention was made in view of the foregoing.

### SUMMARY

In some respects, the invention is directed to coating compositions. The coating compositions comprise: (A) an aqueous dispersion comprising: (i) an aliphatic, fatty-acid containing, anionic polyurethane; and (ii) an acid-reactive crosslinking agent, and (B) a coalescing agent having an evaporation rate of less than 0.8 (n-butyl acetate=1.0) that is present in an amount of at least 2 percent by weight, based on the total weight of the coating composition. The present invention is also directed to, among other things, methods of using such coating compositions and articles coated with a coating deposited from such coating compositions.

It is understood that the invention disclosed and described in this specification is not limited to the embodiments summarized in this Summary. The reader will appreciate the foregoing details, as well as others, upon considering the following detailed description of various non-limiting and non-exhaustive embodiments according to this specification.

### DETAILED DESCRIPTION

Various embodiments are described and illustrated herein to provide an overall understanding of the structure, function, operation, manufacture, and use of the disclosed products and processes. The various embodiments described and illustrated herein are non-limiting and non-exhaustive. Thus, the invention is not limited by the description of the various non-limiting and non-exhaustive embodiments disclosed herein. Rather, the invention is defined solely by the claims. The features and characteristics illustrated and/or described in connection with various embodiments may be combined with the features and characteristics of other embodiments. Such modifications and variations are intended to be included within the scope of this specification. As such, the claims may be amended to recite any features or characteristics expressly or inherently described in, or otherwise expressly or inherently supported by, this specification. Further, Applicant reserves the right to amend the claims to affirmatively disclaim features or characteristics that may be present in the prior art. Therefore, any such amendments comply with the requirements of 35 U.S.C. §112 and 35 U.S.C. §132(a). The various embodiments disclosed and described in this specification can comprise, consist of, or consist essentially of the features and characteristics as variously described herein.

Any patent, publication, or other disclosure material identified herein is incorporated herein by reference in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference herein.

Reference herein to “certain embodiments”, “some embodiments”, “various non-limiting embodiments,” or the like, means that a particular feature or characteristic may be included in an embodiment. Thus, use of such phrases, and similar phrases, herein does not necessarily refer to a common embodiment, and may refer to different embodiments. Further, the particular features or characteristics may be combined in any suitable manner in one or more embodiments. Thus, the particular features or characteristics illustrated or described in connection with various embodiments may be combined, in whole or in part, with the features or characteristics of one or more other embodiments. Such modifications and variations are intended to be included within the scope of the present specification. In this manner, the various embodiments described in this specification are non-limiting and non-exhaustive.

In this specification, other than where otherwise indicated, all numerical parameters are to be understood as being prefaced and modified in all instances by the term “about”, in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Any maximum numerical limitation recited in this specification is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification such that amending to expressly recite any such sub-ranges would comply with the requirements of 35 U.S.C. §112 and 35 U.S.C. §132(a).

The grammatical articles “a”, “an”, and “the”, as used herein, are intended to include “at least one” or “one or more”, unless otherwise indicated, even if “at least one” or “one or more” is expressly used in certain instances. Thus, the articles are used herein to refer to one or more than one (i.e., to “at least one”) of the grammatical objects of the article. Further, the use of a singular noun includes the plural, and the use of a plural noun includes the singular, unless the context of the usage requires otherwise.

As used herein, “polymer” encompasses prepolymers, oligomers and both homopolymers and copolymers; the prefix “poly” in this context referring to two or more. As used herein, “molecular weight”, when used in reference to a polymer, refers to the number average molecular weight (“Mn”), unless otherwise specified. Further, as will be appreciated, the Mn of a polymer containing functional groups, such as a polyol, can be calculated from the functional group number, such as hydroxyl number, which is determined by end-group analysis.

As used herein, the term “aliphatic” refers to organic compounds characterized by substituted or un-substituted straight, branched, and/or cyclic chain arrangements of constituent carbon atoms. Aliphatic compounds do not contain aromatic rings as part of the molecular structure thereof. As used herein, the term “cycloaliphatic” refers to organic compounds characterized by arrangement of carbon atoms in closed ring structures. Cycloaliphatic compounds do not contain aromatic rings as part of the molecular structure of the compounds. Therefore, cycloaliphatic compounds are a subset of aliphatic compounds. Therefore, the term “aliphatic” encompasses aliphatic compounds and/or cycloaliphatic compounds.

As used herein, “diisocyanate” refers to a compound containing two isocyanate groups. As used herein, “polyisocyanate” refers to a compound containing two or more isocyanate groups. Hence, diisocyanates are a subset of polyisocyanates.

As previously indicated, certain embodiments of the present invention are directed to coating compositions. As used herein, the term “coating composition” refers to a mixture of chemical components that will cure and form a coating when applied over a substrate. The coating compositions may be embodied as one-component or two-component compositions.

As used herein, the term “two-component” refers to a coating composition comprising at least two reactive components that are stored in separate containers. For example, in embodiments of the present invention, component (A)(i) and component (A)(ii) are stored in separate containers. In such embodiments, component (B) may be stored with component (A)(i) and/or component (A)(ii) or it may be stored separately from component (A)(i) and (A)(ii). In some embodiments, component (B) is stored with component (A)(i).

As used herein, the term “one-component” refers to a coating composition in which the reactive components are stored together in a single container. For example, in embodiments of the present invention, (A)(i) and (A)(ii) are stored in a single container and provide a one-component coating composition with a pot life of at least 1 week, such as, at least 1 month, at least 2 months, at least 3 months, at least 4 months, at least 5 months, or, in some embodiments, at least 6 months. As used herein, “pot life” refers to the time it takes for the viscosity of the coating composition to increase to 10 times the initial viscosity of the composition. By way of example, if the initial viscosity of a composition is 100 cPs at 23° C., then the pot life of the composition would be the amount of time it takes for the composition to reach a viscosity of 1000 cPs at 23° C. The viscosity of the compositions of the present invention is determined in the manner described in the Examples. In these one-component coating compositions, component (B) is also stored in the container with component (A)(i) and component (A)(ii).

As indicated, the coating compositions of the present invention comprise an aqueous dispersion comprising: (i) an aliphatic, acid-containing, such as fatty acid-containing, anionic polyurethane; and (ii) an acid-reactive crosslinking agent As used herein, the term “aqueous dispersion” means a dispersion of polymeric particles comprising (i) and (ii) in a continuous phase comprising water that is present in an amount of more than 50 percent by weight, based on the weight of the continuous phase. In some embodiments, water is present in the continuous phase in an amount of at least 90 percent by weight, at least 95, at least 96 and/or up to 98 percent by weight, based on the total weight of the continuous phase.

In certain embodiments, the coating compositions of the present invention are prepared by mixing (1) an aqueous dispersion comprising an aliphatic, fatty-acid containing, anionic polyurethane dispersion with (2) an acid-reactive crosslinking agent.

As previously indicated, the polyurethane that is present in the coating compositions of the present invention comprises an aliphatic, acid-containing, such as fatty-acid containing, anionic polyurethane.

In certain embodiments of the present invention, the polyurethane is a reaction product of reactants comprising: (1) a polyisocyanate; (2) at least two polymeric polyols having a number average molecular weight of 500 to 6000 g/mol and comprising: (a) a fatty-acid containing polyester polyol; and (b) a polytetramethylene ether glycol; (3) a compound comprising at least one isocyanate-reactive group and an anionic group or potentially anionic group; (4) a compound with a molecular weight below 500 g/mol and comprising a polyol, an aminopolyol and/or a polyamine; and (5) a monoalcohol having a molecular weight of 32 to 145 g/mol and/or a monoamine having a molecular weight of 17 to 147 g/mol, wherein each of reactants (1)-(5) is different from each other.

In certain embodiments, the polyurethane has a hard segment content of 28 to 85% by weight, such as 30 to 80% by weight, 32 to 75% by weight, or 40 to 60% by weight, based on the total weight of the polyurethane. As used herein, “hard segment content” refers to the weight of all the reactants using to make the polyurethane except for those reactants that constitute component (2) divided by the total weight of reactant used to make the polyurethane multiplied by 100. Those reactants that constitute component (2) may be referred to herein as a “soft segment”. In certain embodiments, the polyurethane has an acid number of at least 15 mg KOH/gram of resin solids, such as at least 20 mg KOH/gram of resin solids and/or up to 40 mg KOH/gram of resin solids, such as up to 30 mg KOH/gram of resin solids, determined according to DIN EN ISO 2114. In certain embodiments, the polyurethane has a calculated amine (“NH”) content of no more than 0.1% of NH equivalents, based on total weight of resin solids.

As indicated, component (1) is a polyisocyanate. Suitable polyisocyanates include aromatic, araliphatic, and aliphatic polyisocyanates, as well as mixtures thereof. In some embodiments, the polyisocyanate comprises a diisocyanate of the formula R¹(NCO)₂, wherein R¹ is an aliphatic hydrocarbon residue having 4 to 12 carbon atoms, such as a cycloaliphatic carbon residue having 6 to 15 carbon atoms; an aromatic hydrocarbon residue having 6 to 15 carbon atoms; or an araliphatic hydrocarbon residue having 7 to 15 carbon atoms.

Suitable polyisocyanates include, for example, 1,3-cyclohexane-diisocyanate, 1-methyl-2,4-diisocyanato-cyclohexane, 1-methyl-2,6-diisocyanato-cyclohexane, tetramethylene-diisocyanate, 4,4′-diisocyanatodiphenylmethane, 2,4′-diisocyanatodiphenylmethane, 2,4-diisocyanatotoluene, 2,6-diisocyanatotoluene, α,α,α′,α′-tetramethyl-m- or -p-xylylene-diisocyanate, 1,6-hexamethylene-diisocyanate, 1-isocyanato-3,3,5-trimethyl-5-isocyanatomethylcyclohexane (isophorone-diisocyanate or IPDI), 4,4′-diisocyanato-dicyclohexylmethane, 1,3-bis(isocyanato-methyl)benzene (XDI), 1,3-bis(1-isocyanato-1-methylethyl)-benzene (TMXDI), 4-isocyanatomethyl-1,8-octane-diisocyanate (triisocyanatononane, TIN), as well homologues or oligomers of such polyisocyanates with, for example, biuret, carbodiimide, isocyanurate, allophanate, iminooxadiazinedione and/or uretdione groups, and mixtures thereof.

In certain embodiments, component (1) is used in an amount of at least 20% by weight, such as at least 30 or at least 35% by weight and/or no more than 60% by weight, such as no more than 50 or, in some cases, no more than 45% by weight, based on the total weight of reactants used to make the polyurethane.

In some embodiments of the present invention, component (2) comprises at least two polymeric polyols having a number average molecular weight of 500 to 6000 g/mol, such as 500 to 3000 g/mol or 650 to 2500 g/mol. The hydroxyl functionality of such polyols is often from 1.8 to 3, such as 1.9 to 2.2 or 1.92 to 2.0.

In certain embodiments of the present invention, the at least two polymeric polyols comprise component (2)(a) which is a fatty-acid containing polyester polyol. Such polyester polyols can be a reaction product of one or more polyols, such as diols, triols, tetrols and/or hexols, and one or more unsaturated fatty acids, optionally further including one or more saturated aliphatic and/or aromatic di- and tri-acids. In certain embodiments, such a polyester polyol has a hydroxyl number of from 15 to 300 mg KOH/g of substance, such as 50 to 180 mg KOH/g of substance, or, in some cases, 70 to 140 mg KOH/g of substance, and an iodine number of greater than 50 g I₂/100 g of substance. “Hydroxyl number”, as used herein, is determined according to DIN 53240. “Iodine number”, as used herein, is determined according to DIN 53241-1.

Suitable polyols for use in preparing the polyester polyol are, for example, ethylene glycol, diethylene glycol, triethylene glycol, tetraethylene glycol, dipropylene glycol, tripropylene glycol, 1,2- and 1,3-propanediol, 1,4-butanediol, neopentyl glycol, 2-ethyl-2-butylpropanediol, trimethylpentanediol, 1,3-butylene glycol, 1,4-cyclohexanedimethanol, 1,6-hexanediol, 1,2- and 1,4-cyclohexanediol, hydrogenated bisphenol A (2,2-bis(4-hydroxycyclohexyl)propane), diols derived from dimer fatty acids, 2,2-dimethyl-3-hydroxypropionic acid, glycerol, tomethylolethane, trimethylolpropane, trimethylolbutane, ditrimethylolpropane, castor oil, partly dehydrated castor oil, pentaerythritol and/or dipentaetythritol.

Suitable unsaturated fatty acids for use in preparing the polyester polyol are, for example, linseed oil fatty acid, soy bean oil fatty acid, sunflower oil fatty acid, rapeseed oil fatty acid and herring oil fatty acid, distilled products which predominantly (>60 wt. %) contain oleic acid, linoleic acid, licanic acid, arachidonic acid, palmitoleic acid, ricinoleic acid and linolenic acid; unsaturated fatty acids which correspond in their composition with respect to the fatty acid radical to the naturally occurring fatty acid mixtures such as can be obtained from plant or animal oils, e.g. soy bean oil, tall oil, linseed oil or sunflower oil. Saturated aliphatic and/or aromatic di- and tri-acids can also be used, such as, for example, phthalic acid, isophthalic acid, terephthalic acid, trimellitic acid, adipic acid, hexahydrophthalic acid, malonic acid, succinic acid, glutaric acid, pimelic acid, suberic acid, sebacic acid, dodecanedioic acid, hydrogenated dimer fatty acids, trimellitic acid and analogous anhydrides thereof.

Suitable polyester polyols also include partly dehydrated castor oil, which is obtained by exposing castor oil to heat under acid catalysis, such as is described in EP-A 709 414 at p. 2, lines 37-40, the cited portion of which being incorporated herein by reference.

In certain embodiments, the polyester polyol comprises the esterification and/or transesterification products of one or more unsaturated fatty acids and/or unsaturated oils with at least bifunctional polyol compound, such as triols or tetra-functional alcohols, such as, for example, trimethylolethane, trimethylolpropane, glycerol, castor oil and pentaerythritol. Such transesterification products are described, for example, in EP-A 017 199 at p. 10, line 27 to p. 11, line 31, the cited portion of which being incorporated herein by reference.

Further suitable polyester polyols from unsaturated fatty acids are described in EP-A 640 632 at p. 2, lines 50-58 and p. 3, lines 10-14, the cited portions of which being incorporated herein by reference. They can be obtained by esterification of unsaturated fatty acids and/or unsaturated oils with polyols. Non-limiting examples of such fatty acids which may be used are linoleic acid, licanic acid, arachidonic acid, palmitoleic acid and/or linolenic acid, such as those which are fatty acid mixtures of plant or animal oils, such as soy bean oil, tall oil, linseed oil or sunflower oil, which are trans esterified with polyols, such as, for example, trimethylolethane, trimethylolpropane, glycerol or pentaerythritol. In some embodiments, the polyester polyol comprises a transesterification product of an unsaturated oil, such as, for example, dehydrogenated castor oil, sunflower oil, soy bean oil, linseed oil, tall oil, olive oil or a mixture thereof, with trimethylolethane, trimethylolpropane, glycerol, pentaerythritol, or a mixture thereof.

In certain embodiments, the fatty-acid containing polyester polyol is a reaction product of an unsaturated fatty acid, such as, for example, oleic acid, lauric acid, linoleic acid or linolenic acid, with castor oil in the presence of glycerol and/or reaction products of unsaturated oils with castor oil. In some embodiments, the unsaturated fatty acid is an unsaturated fatty acid mixture which can be obtained from plant or animal oils, such as, for example, soy bean oil, tall oil, linseed oil, sunflower oil, olive oil, or a mixture thereof.

In certain embodiments, the fatty-acid containing polyester polyol is a transesterification product of castor oil and one or more oils with an iodine number of greater than 100 g I₂/100 g of substance, such as soy bean oil. In some embodiments, the castor oil is used in an amount of 50 to 70 percent by weight and the one or more oils with an iodine number of greater than 100 g I₂/100 g of substance, such as soy bean oil, is used in an amount of 30 to 50 percent by weighty based on the total weight of the reactants used to make the polyester polyol. Castor oil contains a triglyceride having a hydroxyl number of 158 to 169 mg KOH/g of substance and a fatty acid content of 89.5% ricinoleic acid (12-hydroxy-9-cis-octadecenoic acid), 4.2% linoleic acid, 3.0% oleic acid, 1.0% stearic acid, 1.0% palmitic acid, 0.7% dihydoxystearic acid, 0.3% linolenic acid, and 0.3% eicosanoic acid. The major component of castor oil is triricinoleate, which is a triglyceride of the structure:

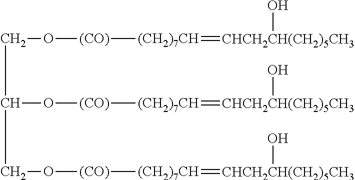

In certain embodiments, component (2)(a) is used in an amount of at least 5% by weight, such as at least 10, at least 15, or at least 18% by weight and/or no more than 50% by weight, such as no more than 30 or, in some cases, no more than 25 or no more than 22% by weight, based on the total weight of reactants used to make the polyurethane. In the certain embodiments, component (2)(a) is used in an amount of at least 30% percent by weight, such as at least 40% by weight and/or no more than 60% by weight, such as no more than 50% by weight, based on the total weight of component (2).

As indicated previously, in certain embodiments, the at least two polymeric polyols also comprise component (2)(b) which is a polytetramethylene ether glycol, which, as will be appreciated, can be produced by polymerization of tetrahydrofuran. In certain embodiments, the polytetramethylene ether glycol comprises a polytetramethylene ether glycol having a number average molecular weight of 650 to 2500 g/mol, such as 1500 to 2500 g/mol, or 1800 to 2200 g/mol. In certain embodiments, component (2)(b) is used in an amount of at least 5% by weight, such as at least 10, at least 15, or at least 20% by weight and/or no more than 50% by weight, such as no more than 40 or, in some cases, no more than 30% by weight, based on the total weight of reactants used to make the polyurethane. In the certain embodiments, component (2)(b) is used in an amount of at least 40% percent by weight, such as at least 50% by weight and/or no more than 70% by weight, such as no more than 60% by weight, based on the total weight of component (2).

Component (2) may, if desired, comprise further additional polymeric polyols (component (2)(c)) having a number average molecular weight of 500 to 6000 g/mol. Suitable such polyols include, but are not limited to, polyethers different from component (2)(b), such as those produced by reaction of an alkylene oxide, such as propylene oxide, with a starter molecule, a polyester different from component (2)(a), polycarbonates, polyacetals, polyester carbonates, polyolefins, polyacrylates, and polysiloxanes, including mixtures thereof.

Suitable polyester polyols include the reaction products of mono-, di- and/or tri-carboxylic acids (and/or their anhydrides) and monomeric diols and/or tools, as well as polyester polyols based on lactones. Suitable carboxylic acids are, for example, phthalic acid, isophthalic acid, terephthalic acid, trimellitic acid, adipic acid, hexahydrophthalic acid, malonic acid, succinic acid, glutaric acid, pimelic acid, suberic acid, sebacic acid, dodecanedioic acid, hydrogenated dimers of fatty acids and saturated fatty acids, such as, for example, palmitic acid and stearic acid.

Suitable polycarbonate polyols can be obtained, for example, by reaction of diols, lactone-modified diols or bisphenols, e.g. bisphenol A, with phosgene or carbonic acid diesters, such as diphenyl carbonate or dimethyl carbonate. Polyether carbonate polyols include, without limitation, those prepared by catalytic conversion of alkylene oxides (epoxides) and carbon dioxide in the presence or absence of H-functional starter substances.

In certain embodiments, when used, component (2)(c) is used in an amount of at least 1% by weight, at least 10 or at least 20% by weight or, in some cases, at least 25% by weight and/or no more than 50% by weight, such as no more than 40 or, in some cases, no more than 35% by weight, based on the total weight of reactants used to make the polyurethane.

In certain embodiments of the present invention, component (3) comprises a compound comprising at least one isocyanate-reactive group and an anionic group or potentially anionic group (for example by salt formation), such as, for example, sulfonium, phosphonium, carboxylate, sulfonate, and/or phosphonate groups. As will be appreciated, isocyanate-reactive groups include, for example, hydroxyl and amino groups.

Compounds containing potentially anionic groups, which are suitable for use in the present invention, include, for example, mono- and di-hydroxycarboxylic acids, mono- and di-aminocarboxylic acids, mono- and di-hydroxysulfonic acids, mono- and di-aminosulfonic acids, mono- and di-hydroxyphosphonic acids, and mono- and di-aminophosphonic acids, as well as mixtures of two or more of any of the foregoing.

In certain embodiments, the compound containing potentially anionic groups comprises dimethylolpropionic acid, dimethylolbutyric acid, hydroxypivalic acid, N-(2-aminoethyl)-alanine, 2-(2-amino-ethylamino)-ethanesulfonic acid, ethylenediamine-propyl- or -butylsulfonic acid, 1,2- or 1,3-propylenediamine-ethylsulfonic acid, 3-(cyclohexylamino)propane-1-sulfonic acid, malic acid, citric acid, glycollic acid, lactic acid, glycine, alanine, taurine, lysine, 3,5-diaminobenzoic acid, an addition product of isophoronediamine and acrylic acid (such as is described in Example 1 of EP-A 916 647, the cited portion of which being incorporated herein by reference), the adduct of sodium bisulfite on but-2-ene-1,4-diol polyether sulfonate, and the propoxylated adduct of 2-butenediol and NaHSO₃ (such as is described by formula I-III of DE-A 2 446 440 at page 5-9, the cited portion of which being incorporated herein by reference), as well as mixtures of two or more of any of the foregoing.

In some cases, the compound containing potentially anionic groups comprises a compound containing carboxyl and/or sulfonic acid groups, such as, for example, 2-(2-amino-ethylamino)-ethanesulfonic acid, 3-(cyclohexylamino)propane-1-sulfonic acid, the addition product of isophoronediamine and acrylic acid, hydroxypivalic acid, and/or dimethylolpropionic acid.

In embodiments, component (3) is used in an amount of at least 0.1% by weight, such as at least 1, or at least 3% by weight and/or no more than 10% by weight, such as no more than 7% by weight, based on the total weight of reactants used to make the polyurethane.

In some embodiments, component (4) comprises a compound with a molecular weight below 500 g/mol that is a polyol, an aminopolyol and/or a polyamine, and which may function, for example, as a chain extender. In certain embodiments, component (4) comprises a compound with a molecular weight of 62 to less than 500, 62 to 400 or, in some cases, 90 to 300. Specific examples of such polyols, aminoalcohols and polyamines that are suitable for use as component (4) include, but are not limited to, ethanediol, 1,2- and 1,3-propanediol, 1,2-, 1,3- and 1,4-butanediol, 1,5-pentanediol, 1,6-hexanediol, neopentyl glycol, cyclohexane-1,4-dimethanol, 1,2- and 1,4-cyclohexanediol, 2-ethyl-2-butylpropanediol, diols containing ether oxygen (such as diethylene glycol, methylene glycol, tetraethylene glycol, dipropylene glycol, tripropylene glycol, polyethylene, polypropylene or polybutylene glycols), trimethylolpropane, glycerol, hydrazine, ethylenediamine, diethylenetriamine, 1,4-diaminobutane, isophoronediamine and 4,4-diaminodicyclohexylmethane, as well as mixtures of any of the foregoing.

In certain embodiments, when used, component (4) is used in an amount of at least 0.1% by weight, such as at least 1 or, in some cases, at least 3% by weight and/or no more than 10% by weight, such as no more than 7% by weight, based on the total weight of reactants used to make the polyurethane. In certain embodiments, component (4) comprises a polyol and a polyamine, wherein the polyol comprises a diol that is present in an amount of at least 50% by weight, such as at least 55% by weight and/or no more than 70% by weight, such as no more than 60% by weight, based on the total weight of component (4), and/or the polyamine comprises a diamine and a triamine, wherein the diamine is present in an amount of at least 20% by weight, such as at least 30% by weight and/or no more than 50% by weight, such as no more than 35% by weight, based on the total weight of component (4) and the triamine is present in an amount of at least 1% by weight, such as at least 5% by weight and/or no more than 20% by weight, such as no more than 10% by weight, based on the total weight of component (4).

Component (5) comprises a monoalcohol having a molecular weight of 32 to 145 g/mol and/or a monoamine having a molecular weight of 17 to 147 g/mol, which can function as a chain terminator to, for example, regulate the molecular weight of the polyurethane. Specific examples of monoalcohols and monoamines, such as mono-secondary amines, that are suitable include, without limitation, aliphatic monoalcohols or monoamines having 1-18 carbon atoms, specific examples of which include, but are not limited to, ethanol, n-butanol, ethylene glycol monobutyl ether, 2-ethylhexanol, 1-octanol, 1-dodecanol, 1-hexadecanol methylamine, ethylamine, propylamine, butylamine, octylamine, laurylamine, stearylamine, isononyloxypropylamine, dimethylamine, diethylamine, dipropylamine, dibutylamine, N-methylaminopropylamine, diethyl(methyl)aminopropylamine, morpholine, piperidine or the substituted derivatives thereof, amido amines from diprimary amines and monocarboxylic acids, monoketimines of diprimary amines, primary/tertiary amines, such as N,N-dimethylaminopropylamine.

In certain embodiments, when used, component (5) is used in an amount of at least 0.1% by weight, such as at least 0.2% by weight and/or no more than 10% by weight, such as no more than 5 or, in some cases, no more than 1% by weight, based on the total weight of reactants used to make the polyurethane.

In some embodiments, the sum of components (1)-(5) is 100 percent by weight, based on the total weight of the reactants used to make the polyurethane.

In some embodiments, the polyurethane is not a polyurethane acrylate.

Any of a variety of processes can be used to prepare the aqueous polyurethane dispersions used in embodiments of the present invention. For example, in some embodiments, a polyester oligomer is initially produced by esterification and/or transesterification from castor oil, one or more alcohols and unsaturated fatty acids or from castor oil and one or more triglycerides, such as those having an iodine value of >50, such as >100 g I₂/100 g of substance, and a polyurethane dispersion is then prepared from this preliminary product.

The process for the producing such a polyester oligomer may be performed in such a manner that the starting materials are heated to elevated temperatures of for example 200-250° C., often in the presence of a catalyst. The course of the esterification or transesterification reaction may, for example, be monitored by gel chromatography. Catalysts which may be used include the basic or acidic catalysts, such as sodium hydroxide, lithium hydroxide, lead oxide, lithium acetate, organotitanium, organozirconium, organozinc and organotin compounds.

The aqueous polyurethane dispersion can be produced by allowing the polyisocyanate to react to completion with polymeric polyol(s) and low molecular weight chain extenders) to yield a polyurethane, wherein a solvent may be used which may optionally subsequently be separated. Suitable solvents include, for example, ethyl acetate, butyl acetate, ethylene glycol monomethyl or monoethyl ether acetate, 1-methoxy-2-propyl acetate, 3-methoxy-n-butyl acetate, acetone, 2-butanone, 4-methyl-2-pentanone, cyclohexanone, toluene, xylene, chlorobenzene, mineral spirits, mixtures primarily containing relatively highly substituted aromatics, as are commercially available for example under the names Solvent Naphtha, Solvesso® (Exxon), Cypar® (Shell), Cyclo Sol® (Shell), Tolu Sol® (Shell), Shellsol® (Shell), carbonic acid esters, such as dimethyl carbonate, diethyl carbonate, 1,2-ethylene carbonate and 1,2-propylene carbonate, lactones, such as β-propiolactone, γ-butyrolactone, ε-caprolactone and ε-methylcaprolactone, as well as propylene glycol diacetate, diethylene glycol dimethyl ether, dipropylene glycol dimethyl ether, diethylene glycol ethyl and butyl ether acetate, N-methylpyrrolidone and N-methylcaprolactam, or any desired mixtures of such solvents.

In a further step, groups capable of neutralization are converted into the salt form by neutralization and the dispersion is produced with water. Depending upon the degree of neutralization, the dispersion may, if desired, be adjusted to a very finely divided state.

Excess isocyanate groups can then be reacted with polyfunctional isocyanate-reactive compounds (chain extension). To this end, polyamines are often used, such as those described earlier. Termination with a monoamine, such as those described earlier, is also possible.

In some embodiments, the polyurethane dispersion is prepared by a method that provides a polyurethane dispersion that is free of N-methylpyrrolidone and other solvents. In such embodiments, the aqueous polyurethane dispersion can be prepared by (A) preparing in a first step an isocyanate-functional prepolymer solution which has a concentration of 66% to 98% by weight in a solvent having a boiling point of below 100° C. at atmospheric pressure, in which the prepolymer is the reaction product of: components (1), (2), (3), and optionally (5), as described above, (B) in a second step dispersing the isocyanate-functional prepolymer in water and at least partly neutralizing the potential ionic groups to form ionic groups before, during or after the dispersion, (C) in a third step chain extending isocyanate-functional prepolymer with component (4), and (D) in a fourth step removing the solvent completely by distillation.

Suitable solvents for use in step (A) are those which boil below 100° C. under atmospheric pressure, contain no isocyanate-reactive groups, are water-soluble, and are removable by distillation from the dispersion. Specific examples of such solvents include acetone, methyl ethyl ketone, tert-butyl methyl ether or tetrahydrofuran.

The preparation of such solvent-free, aqueous polyurethane dispersions can proceed in four steps. First the isocyanate-functional prepolymer is prepared. In certain embodiments, the isocyanate-functional prepolymer has an isocyanate functionality of <2.3. The solvent can be added before, during or after polymerization in an amount sufficient to form a solid with a resin solids content of 66% to 98% by weight, such as 75% to 95% by weight. The neutralizing agent may be present at the beginning of the reaction, may be added to the finished prepolymer, or may be added to the dispersing water. Alternatively, the amount of neutralizing agent can be divided between the organic and aqueous phase prior to dispersion.

In a second step the isocyanate-functional prepolymer is dispersed by either adding water to the resin or by adding the resin to water under adequate shearing conditions. In the third step, chain extension is carried out using an amount of chain extender that is sufficient to react with 25% to 105%, such as 55% to 100%, or, in some cases, 55% to 90% of the isocyanate groups. The remaining isocyanate groups react with the water present. In the fourth step the solvent is completely removed by distillation, preferably under reduced pressure.

As used herein, “solvent-free” means that the dispersion contains ≦0.9% by weight, such as ≦0.5% by weight, or, in some cases, ≦0.3% by weight of solvent.

Suitable processes for making the foregoing solvent-free aqueous polyurethane dispersions are generally described in U.S. Patent Application Publication No. 2006/0241228 A1, at [0009]-[0042], the cited portion of which being incorporated herein by reference.

In certain embodiments, the resin solids content of the aqueous polyurethane dispersion prepared by any of the methods described herein, such as a solvent-free dispersion, is at least 20% by weight, such as at least 25 or at least 30% by weight and/or no more than 65% by weight, such as no more than 50 or no more than 45% by weight, based on the total weight of the dispersion. In certain embodiments, the aqueous polyurethane dispersion has a minimum film formation temperature (“MFFT”) of at least 30° C. As used herein, MFFT refers to the lowest temperature at which the polymer particles in the composition will uniformly coalesce when laid on a substrate as a thin film, and is measured using a MFFT-BAR, as specified by ASTM D 2354.

One example of an aqueous polyurethane dispersion that is suitable for use in the coating compositions of the present invention is Bayhydrol® UH 2557, an aliphatic, fatty acid-containing, solvent-free anionic polyurethane dispersion, 35% by weight resin solids in water, neutralized with triethylamine, from Bayer MaterialScience AG, Leverkusen, Germany.

As indicated, the coating compositions of the present invention comprise an acid-reactive crosslinking agent As used herein, “acid-reactive” refers to a compound containing functional groups reactive with acid groups. As water in the composition applied over the substrate evaporates, the acid groups of the polyurethane react with the acid-reactive groups of the crosslinking agent thereby crosslinking the polyurethane with the cross-linking agent. Acid-reactive crosslinking agents suitable for use in the present invention include, for example, compounds comprising epoxy, carbodiimide, aziridine and/or oxazoline groups.

In certain embodiments, the crosslinking agent comprises an aqueous aliphatic polycarbodiimide dispersion and the coating compositions of the present invention can be prepared by mixing the aqueous polyurethane dispersion described above with an aqueous aliphatic polycatbodiimide dispersion. As will be appreciated, and as used herein, the term polycarbodiimide refers to a polymer containing two or more units of the structure:

—N═C═N—.

Polycarbodiimides can be prepared by condensation reaction of a polyisocyanate in the presence of a suitable catalyst to form a polycarbodiimide having terminal isocyanate groups.

The polycarbodiimides used in the coating compositions of the present invention are aliphatic. As a result, they are derived from one or more aliphatic polyisocyanates. Suitable aliphatic polyisocyanates include, for example, 4,4′-dicyclohexylmethane diisocyanate (also known as PICM, hydrogenated MDI (HMDI or H12MDI), saturated MDI (SMDI), or reduced MDI (RMDI), 1,6-hexamethylene diisocyanate (HDI), isophorone diisocyanate (IPDI), 1,4-cyclohexane diisocyanate (CHDI), 1,3-bis(isocyanatomethyl)cyclohcxane (H-XDI), m-tetramethylxylene diisocyanate (m-TMXDI), and mixtures thereof, among others.

In order to form an aqueous aliphatic polycarbodiimide dispersion suitable for use in the present invention, a polycarbodiimide having terminal isocyanate groups is modified to be hydrophilic. This can be accomplished by reacting the terminal isocyanate groups with one or more hydrophilic active-hydrogen compounds, such as monothiols, monoamines, and/or mono alcohols, such that the resulting polycarbodiimide contains substantially no remaining isocyanate functionality. In certain embodiments, the hydrophilic active-hydrogen compound comprises one or more monoalcohols. Examples of monoalcohols that are suitable for use in preparing the aqueous aliphatic polycarbodiimide dispersion include, without limitation, aliphatic monoalcohols having 1-18 carbon atoms, specific examples of which include, but are not limited to, ethanol, n-butanol, 2-ethylhexanol, 1-octanol, 1-dodecanol, 1-hexadecanol, as well as poly(alkylene oxide) monoalkyl ethers, such as, for example, poly(ethylene oxide) monomethyl ethers. As will be appreciated, two or more of the various monoalcohols described above can be used.

The solids content of the aqueous polycarbodiimide dispersion is, in certain embodiments, at least 25% by weight, such as at least 30 or, in some cases, at least 35% by weight and/or no more than 65% by weight, such as no more than 50 or, in some cases, no more than 45% by weight, based on the total weight of the dispersion.

One example of an aqueous aliphatic polycarbodiimide dispersion that is suitable for use in the coating compositions of the present invention is Desmodur® XP 2802, a waterborne dispersion of a hydrophilically modified, aliphatic polycarbodiimide, 40% by weight resin solids in water, Bayer MaterialScience AG, Leverkusen, Germany.

In certain embodiments, the aqueous aliphatic, fatty-acid containing, anionic polyurethane dispersion is present in the coating composition in an amount of at least 50% by weight, such as at least 70% by weight and/or up to 98% by weight, such as up to 90% by weight or up to 80% by weight, based on the total weight of the coating composition. Moreover, in certain embodiments, the acid-reactive crosslinking agent, such as the aqueous aliphatic polycarbodiimide dispersion, is present in an amount of greater than 2% up to 10% by weight, such as greater than 2% up to 8% by weight, or, in some cases 3% to 6% by weight, based on the total weight of the coating composition. In certain embodiments, the coating compositions of the present invention comprise an aqueous dispersion comprising: at least 50% by weight, at least 70% by weight, at least 80% by weight or at least 90% by weight and/or up to 99.4% by weight, up to 99% by weight up to 98% by weight, up to 97% by weight, up to 96% by weight, up to 95% by weight, or, up to 94% by weight of an aliphatic, fatty-acid containing, anionic polyurethane, and at least 0.6% by weight, such as at least 0.8% by weight, or, in some cases at least 1.0% by weight, at least 1.5% by weight, or at least 2.0% by weight and/or up to 6.0% by weight, or, in some cases, up to 5.0% by weight up to 4.0% by weight, and/or up to 3.0% by weight of acid-reactive crosslinking agent such as an aliphatic polycarbodiimide, such weight percents being based on the total weight resin solids in the coating composition. In certain embodiments, the acid-reactive crosslinking agent, such as an aliphatic polycarbodiimide, is present in the coating composition in an amount such that there is an excess of acid groups in the composition relative to the amount of acid-reactive groups, such as carbodiimide groups.

The coating compositions of the present invention comprise (B) at least 2 percent by weight of a coalescing agent, based on the total weight of the composition. As used herein, “coalescing agent” is synonymous with “cosolvent” and refers to organic solvent that is a volatile organic compound (“VOC”) having an evaporation rate of less than 0.8, in some cases less than 0.1, and, in yet other cases, less than 0.01 relative to n-butyl acetate (n-butyl acetate=1.0).

As used herein, the term “volatile organic compound” refers to any compound of carbon, excluding carbon monoxide, carbon dioxide, carbonic acid, metallic carbides or carbonates, and ammonium carbonate, which participates in atmospheric photochemical reactions and corresponds to the compounds as set forth in 40 CFR Part 51.100(s) (as of Mar. 26, 2014).

In certain embodiments, the coalescing agent comprises a solvent that is at least partially soluble in water (i.e., at least one part of the solvent dissolves in two part of water) and, in some cases, is completely miscible in water. The use, however, of some hydrophobic coalescing agents, i.e., those that are not at least partially soluble or miscible in water (such as dipropylene glycol n-butyl ether), is not excluded. Specific examples of coalescing agents that are suitable for use in the present invention include ethylene oxide-based and/or propylene oxide-based glycol ether solvents, such as ethylene glycol monohexyl ether, diethylene glycol monomethyl ether, diethylene glycol monoethyl ether, diethylene glycol monopropyl ether, diethylene glycol monobutyl ether, ethylene glycol monobutyl ether acetate, diethylene glycol monoethyl ether acetate, dipropylene glycol n-butyl ether, including mixtures of two or more thereof.

In the coating compositions of the present invention the coalescing agent is present in the coating composition in an amount of at least 2% by weight, such as 2 to 10% by weight, 2 to 5% by weight, 3 to 5% by weight, or, in some cases, 3.5 to 4.5% by weight, based on the total weight of the coating composition. In certain embodiments, the coating composition comprises (a) a water soluble coalescing agent and (b) a hydrophobic coalescing agent, wherein the relative weight percentages of (a) and (b) in the coating composition is at least 1:1.

The coating compositions of the present invention may further include any of a variety of coating additives such as defoamers, devolatilizers, thickeners, flow control additives, colorants (including pigments and dyes) or surface additives.

Suitable defoamers include mineral oil defoamers, silicone defoamers, polymeric, silicone-free defoamers, and polyethersiloxane copolymers. Suitable devolatilizers include polyacrylates, dimethylpolysiloxanes, organically modified polysiloxanes such as polyoxyalkyldimethylsiloxanes, and fluorosilicones. Suitable thickeners include natural organic thickeners such as dextrins or starch; organically modified natural substances such as cellulose ethers or hydroxyethylcellulose; all-synthetic organic thickeners such as poly(meth)acrylic compounds or polyurethanes; and inorganic thickeners such as bentonites or silicas. Suitable flow control additives or surface additives include silicone additives, ionogenic or nonionogenic acrylates or low molecular weight, surface-active polymers. Substrate-wetting silicone surfactants, such as polyether-modified polydimethylsiloxanes, may also be added.

Suitable methods for preparing the coating compositions of the present invention are described in the Examples. As mentioned earlier, the coating compositions can be embodied as a one-component (1K) composition or as a two-component (2K) composition.

The coating compositions may be applied onto surfaces using various techniques, such as spraying, dipping, flow coating, rolling, brushing, pouring, and the like. In the compositions of the present invention, the polyurethane particles can coalesce to form a continuous film at ambient temperature, i.e., such as 20° C. to less than 30° C., such as 20° C. to 25° C. or less, if desired. As water in the coating composition evaporates, the acid groups of the aliphatic, fatty-acid containing, anionic polyurethane will react with the the acid-reactive crosslinking agent, such as the carbodiimide groups of the aliphatic polycarbodiimide, thereby crosslinking the polyurethane with the acid-reactive crosslinking agent to form a cured coating. The crosslinking reactions may occur at ambient temperature, i.e., below 30° C., or higher temperatures, such as 40° C. to 200° C., if desired.

The coating compositions can be applied onto any compatible substrate, such as, for example, metals, plastics (such as vinyl, such as PVC), ceramics, glass, concrete, and other organic or inorganic materials or natural materials, and to substrates that have been subjected to any pre-treatment that may be desirable.

It has been surprisingly discovered, however, that the coating compositions of the present invention are particularly suitable for use on a frame of an architectural article, such as a door or window frame, particularly those that are constructed of a vinyl material, such as PVC. Indeed, it has been discovered, surprisingly, that coating compositions described herein, which, as described above, can have a long pot life, and which comprise an aqueous dispersion comprising a particular combination of (A) an aliphatic, fatty-acid containing, anionic polyurethane as described herein; and (B) an acid-reactive crosslinking agent as described herein, when deposited upon a substrate comprising a vinyl material (such as PVC), can produce a cured coating that, when used as a frame of an architectural article, such as a door or window, meets or exceeds many if not all of the requirements of AAMA specification 615-05, Performance Requirements and Test Procedures for Superior Performing Organic Coatings on Plastic Profiles, revised December 2005 (referred to herein as “AAMA 615-5”).

For example, cured coatings deposited from the coating compositions of the present invention, when deposited over a synthetic substrate, such as PVC, pass the dry adhesion and boiling water adhesion tests described in AAMA 615-05, section 6.4 and the detergent resistance test described in AAMA 615-05, section 6.7.4.

As will be appreciated by the foregoing description, embodiments of the present invention are directed to coating compositions comprising: (A) an aqueous dispersion comprising: (i) an aliphatic, acid containing, such as fatty-acid containing, anionic polyurethane; and (ii) an acid-reactive crosslinking agent, and (B) a coalescing agent having an evaporation rate of less than 0.8 (n-butyl acetate=1.0) that is present in an amount of at least 2 percent by weight, based on the total weight of the coating composition.

Some embodiments of the present invention are directed to a coating composition of the previous paragraph, wherein the coating composition has a pot life of at least 1 month, at least 2 months, at least 3 months, at least 4 months, at least 5 months, or, in some embodiments, at least 6 months.

Embodiments of the present invention are also directed to a coating composition of either of the previous two paragraphs, wherein the polyurethane is a reaction product of reactants comprising: (1) a polyisocyanate; (2) at least two polymeric polyols having a number average molecular weight of 500 to 6000 and comprising: (a) a fatty-acid containing polyester polyol; and (b) a polytetramethylene ether glycol; (3) a compound comprising at least one isocyanate-reactive group and an anionic group or potentially anionic group; (4) a compound with a molecular weight below 500 g/mol and comprising a polyol, an aminopolyol and/or a polyamine; and (5) a monoalcohol having a molecular weight of 32 to 145 g/mol and/or a monoamine having a molecular weight of 17 to 147 g/mol, wherein each of reactants (1)-(5) is different from each other. In some of these cases, the polyurethane has a hard segment content of 40 to 60% by weight, based on the total weight of the polyurethane and/or a calculated amine content of no more than 0.1% of NH equivalents, based on total weight of resin solids.

In certain embodiments, the present invention is directed to a coating composition of any of the previous three paragraphs, wherein the fatty-acid containing polyester polyol is a transesterification product of castor oil and one or more oils with an iodine number of greater than 100 g I₂/100 g of substance, such as wherein the one or more oils with an iodine number of greater than 100 g I₂/100 g of substance comprises soy bean oil, such as wherein the castor oil is used in an amount of 50 to 70 percent by weight and the soy bean oil is used in an amount of 30 to 50 percent by weight, the weight percents being based on the total weight of the reactants used to make the polyester polyol.

Embodiments of the present invention are also directed to a coating composition of any of the previous two paragraphs, wherein component (2)(a) is used in an amount of at least 40% by weight and no more than 50% by weight, based on the total weight of component (2) and component (2)(b) is used in an amount of at least at least 50% by weight and no more than 60% by weight, based on the total weight of component (2).

Some embodiments of the present invention are directed to a coating composition of any of the previous three paragraphs, wherein component (4) comprises a polyol and a polyamine, wherein (i) the polyol comprises a diol that is present in an amount of at least 50% by weight and/or no more than 70% by weight, based on the total weight of component (4), and (ii) the polyamine comprises a diamine and a triamine, wherein the diamine is present in an amount of at least 20% by weight and no more than 50% by weight, based on the total weight of component (4), and the triamine is present in an amount of at least 5% by weight and no more than 10% by weight, based on the total weight of component (4).

In some embodiments, the present invention is directed to a coating composition of any of the previous six paragraphs wherein the acid-reactive crosslinking agent comprises a polycarbodiimide, such as wherein the polycarbodiimide is a condensation reaction product of a polyisocyanate in the presence of a suitable catalyst, wherein the polyisocyanate comprises an aliphatic polyisocyanate comprising 4,4′-dicyclohexylmethane diisocyanate.

Certain embodiments of the present invention are directed to a coating composition of any of the previous seven paragraphs, wherein the coating composition comprises a mixture of: (a) an aqueous aliphatic, fatty-acid containing, anionic polyurethane dispersion present in an amount of at least 70% by weight and up to 98% by weight, based on the total weight of the coating composition; and (b) an acid-reactive crosslinking agent comprising an aqueous aliphatic polycarbodiimide dispersion present in an amount of greater than 2% up to 10% by weight, based on the total weight of the coating composition.

Embodiments of the present invention are also directed to a coating composition of any of the previous eight paragraphs, wherein the coalescing agent, has an evaporation rate of less than 0.01 relative to n-butyl acetate (n-butyl acetate=1.0).

Some embodiments of the present invention are directed to a coating composition of any of the previous nine paragraphs, in which the coalescing agent is completely miscible in water.

In some respects, the present invention is directed to a method of using the coating composition of any of the previous ten paragraphs, comprising applying the coating composition to a surface comprising a polyvinyl material comprising polyvinyl chloride. As will also be appreciated by the foregoing description the present invention is also directed to an article having a coating deposited thereon, wherein the coating is deposited from a coating composition of any of the previous ten paragraphs.

As will also be appreciated by the foregoing, embodiments of the present invention are also directed to coating compositions comprising: (A) an aqueous dispersion comprising: (i) an aliphatic, fatty-acid containing, anionic polyurethane polyurethane having a hard segment content of 40 to 60% by weight, based on the total weight of the polyurethane, and comprising a reaction product of reactants comprising: (1) a polyisocyanate; (2) at least two polymeric polyols having a number average molecular weight of 500 to 6000 and comprising: (a) a fatty-acid containing polyester polyol that is a transesterification product of castor oil and soy bean oil; and (b) a polytetramethylene ether glycol; (3) a compound comprising at least one isocyanate-reactive group and an anionic group or potentially anionic group; (4) a compound with a molecular weight below 500 g/mol and comprising a polyol, an aminopolyol and/or a polyamine; and (5) a monoalcohol having a molecular weight of 32 to 145 g/mol and/or a monoamine having a molecular weight of 17 to 147 g/mol, wherein each of reactants (1)-(5) is different from each other; and (ii) an acid-reactive crosslinking agent comprising a compound comprising epoxy, carbodiimide, aziridine and/or oxazoline groups, and (B) a coalescing agent having an evaporation rate of less than 0.8 (n-butyl acetate=1.0) that is present in an amount of at least 2 percent by weight, based on the total weight of the coating composition, wherein the coating composition has a pot-life of at least 1 month, at least 2 months, at least 3 months, at least 4 months, at least 5 months, or, in some embodiments, at least 6 months.

Some embodiments of the present invention are directed to a coating composition of the previous paragraph, wherein component (2)(a) is used in an amount of at least 40% by weight and no more than 50% by weight, based on the total weight of component (2) and component (2)(b) is used in an amount of at least at least 50% by weight and no more than 60% by weight, based on the total weight of component (2).

Certain embodiments of the present invention are directed to a coating composition of any of the previous two paragraphs, wherein component (4) comprises a polyol and a polyamine, wherein (i) the polyol comprises a diol that is present in an amount of at least 50% by weight and/or no more than 70% by weight; based on the total weight of component (4), and (ii) the polyamine comprises a diamine and a triamine, wherein the diamine is present in an amount of at least 20% by weight and no more than 50% by weight, based on the total weight of component (4), and the triamine is present in an amount of at least 5% by weight and no more than 10% by weight, based on the total weight of component (4).

Embodiments of the present invention are also directed to a coating composition of any of the previous three paragraphs, wherein the crosslinking agent comprises a polycarbodiimide comprising a condensation reaction product of a polyisocyanate in the presence of a suitable catalyst, wherein the polyisocyanate comprises an aliphatic polyisocyanate comprising 4,4′-dicyclohexylmethane diisocyanate.

In some embodiments, the present invention is directed to a coating composition of any of the previous four paragraphs, wherein the coating composition comprises a mixture of: (a) an aqueous aliphatic, fatty-acid containing, anionic polyurethane dispersion present in an amount of at least 70% by weight and up to 98% by weight, based on the total weight of the coating composition; and (b) an acid-reactive crosslinking agent comprising an aqueous aliphatic polycarbodiimide dispersion present in an amount of greater than 2% up to 10% by weight, based on the total weight of the coating composition.

In certain embodiments, the present invention is directed to a coating composition of any of the previous five paragraphs, wherein the coalescing agent, has an evaporation rate of less than 0.01 relative to n-butyl acetate (n-butyl acetate=1.0).

Embodiments of the present invention are also directed to a method of using a coating composition of any of the previous six paragraphs, comprising applying the coating composition to a surface comprising a polyvinyl material comprising polyvinyl chloride. Embodiments of the present invention are also directed to an article having a coating deposited thereon, wherein the coating is deposited from a coating composition of any of the previous six paragraphs, wherein the article is a frame of an architectural article, such as where the the coating passes the dry adhesion and boiling water adhesion tests described in AAMA 615-05, section 6A and the detergent resistance test described in AAMA 615-05, section 6.7.4.

The non-limiting and non-exhaustive examples that follow are intended to further describe various non-limiting and non-exhaustive embodiments without restricting the scope of the embodiments described in this specification.

### EXAMPLES

### Example 1

Formulations 1A-1P were prepared using the ingredients and amounts (in grams) listed in Table 1. To prepare the component 1, the polyurethane dispersion was added into a small mixing container. A mixer was added and the polyurethane dispersion was mixed under low shear conditions. In another container, the other ingredients of component 1 were pre-mixed. This mixture was then added slowly into the polyurethane dispersion to form component 1. Component 1 was mixed until homogeneous (˜20 minutes under low shear conditions). Once component 1 was thoroughly mixed, component 2 (where used) was added and stirred in with a paint stick by hand for several minutes. Upon completion of the mixing, the formulation was ready for application and testing.

TABLE 1

| Example | 1A | 1B | 1C | 1D | 1E | 1F | 1G | 1H | 1I | 1J | 1K | 1L | 1M | 1N | 1O | 1P |
|---|---|---|---|---|---|---|---|---|---|---|---|---|---|---|---|---|
| Component 1 | | | | | | | | | | | | | | | | |
| Bayhydrol ® UH 2593/1¹ | 80 | 80 | 80 | 80 | — | — | — | — | — | — | — | — | — | — | — | — |
| Deionized water | 4.4 | 4.4 | 4.4 | 4.4 | 4.4 | 4.4 | 4.4 | 4.4 | 4.4 | 4.4 | 4.4 | 4.4 | 4.4 | 4.4 | 4.4 | 4.4 |
| Butyl CARBITOL ™² | 4.4 | 4.4 | 4.4 | 4.4 | 4.4 | 4.4 | 4.4 | 4.4 | 4.4 | 4.4 | 4.4 | 4.4 | 4.4 | 4.4 | 4.4 | 4.4 |
| BYK-349³ | 0.2 | 0.2 | 0.2 | 0.2 | 0.2 | 0.2 | 0.2 | 0.2 | 0.2 | 0.2 | 0.2 | 0.2 | 0.2 | 0.2 | 0.2 | 0.2 |
| Bayhydrol ® UH 2557⁴ | — | — | — | — | 80 | 80 | 80 | 80 | — | — | — | — | — | — | — | — |
| Bayhydrol ® UH XP 2592⁵ | — | — | — | — | — | — | — | — | 80 | 80 | 80 | 80 | — | — | — | — |
| Bayhydrol ® UH 2558⁶ | — | — | — | — | — | — | — | — | — | — | — | — | 80 | 80 | 80 | 80 |
| Borchi ® OXY - Coat⁷ | — | — | — | — | — | — | — | — | 1.15 | 1.15 | 1.15 | 1.15 | — | — | — | — |
| Component 2 | | | | | | | | | | | | | | | | |
| Desmodur ® XP 2802⁸ | — | 1.8 | 3.6 | 5.4 | — | 1.8 | 3.6 | 5.4 | — | 1.8 | 3.6 | 5.4 | — | 1.8 | 3.6 | 5.4 |

¹A cosolvent free aliphatic, anionic fatty acid-modified polyurethane dispersion having a minimum film-forming temperature of 40° C. in which the soft segment is a fatty acid containing polyester polyol and a polyether polyol based on propylene oxide, Bayer MaterialScience LLC, Pittsburgh, PA.
²Diethylene Glycol Monobutyl Ether, The Dow Chemical Company, Midland, Michigan.
³Silicone surfactant, BYK USA Inc.
⁴A solvent-free aliphatic, anionic fatty acid-modified polyurethane dispersion having a minimum film-forming temperature of 30° C. in which the soft segment is a fatty acid containing polyester polyol and polytetrahydrofuran, Bayer MaterialScience LLC, Pittsburgh, PA.
⁵An aliphatic, oxidative drying polyester-polyurethane dispersion that is not fatty acid-modified, Bayer MaterialScience LLC, Pittsburgh, PA.
⁶A cosolvent free aliphatic, anionic polyurethane dispersion that is not fatty acid-modified, Bayer MaterialScience LLC, Pittsburgh, PA.
⁷A 1% solution of an iron complex catalyst in 1,2-propylene glycol, OMG Borchers GmbH.
⁸A waterborne dispersion of a hydrophilically modified, aliphatic polycarbodiimide, 40% by weight resin solids in water, Bayer MaterialScience AG, Leverkusen, Germany.

Each of formulations 1A-1P were drawn-down on iron phosphate pre-treated (Bonderite® 1000) steel test panels to a wet film thickness of 5 mils (127 μm) and the samples were allowed to cure at 72° F. (22.2° C.) and 50% relative humidity for a period of 7 days prior to testing. Chemical spot testing was completed by exposing the surface of the coating to a chemical as listed in Table 2 for a 1-hour time period. Upon completion of this time period the chemical resistance of the coating was assessed based on the swelling of the film when exposed to the chemical. Results of the chemical spot testing are set forth in Table 2 in which “Fail” means the coating exhibited a loss of adhesion or blistering of the coating film was completely destroying, “Soften” means that when one applied slight pressure with a paint stick the coating was scratched or damaged, and “Pass” means when slight pressure was applied with a paint stick there was no effect on the surface of the coating.

TABLE 2

Chemical

| Example | methyl ethyl ketone | Isopropyl alcohol |
|---|---|---|
| 1A | Fail | Fail |
| 1B | Fail | Fail |
| 1C | Soften | Fail |
| 1D | Pass | Fail |
| 1E | Fail | Fail |
| 1F | Pass | Fail |
| 1G | Pass | Pass |
| 1H | Pass | Pass |
| 1I | Fail | Fail |
| 1J | Fail | Fail |
| 1K | Fail | Fail |
| 1L | Fail | Fail |
| 1M | Fail | Fail |
| 1N | Fail | Fail |
| 1O | Fail | Fail |
| 1P | Fail | Fail |

The pot-life of each of formulations 1A-1P was evaluated by measuring the increase in viscosity of the formulation over time. To determine the pot-life, 100 grams of the sample was added into a 2 ounce (59.1 milliliter) jar. The jar was sealed and then opened periodically to determine the viscosity in centipoise (cPs) at 23° C. of the formulation in the jar. In each case, the formulation was stored at room temperature throughout the testing period and viscosity was measured on a Brookfieid viscometer (DV-I™ Viscometer from Brookfield Engineering) using spindle #2 @ 100 rpm. Results are set forth in Table 3.

TABLE 3

| | 1A | 1B | 1C | 1D | 1E | 1F | 1G | 1H | 1I | 1J | 1K | 1L | 1M | 1N | 1O | 1P |
|---|---|---|---|---|---|---|---|---|---|---|---|---|---|---|---|---|
| Initial Viscosity | 91 | 117.1 | 208 | 225 | 41.4 | 53.8 | 77.6 | 59.3 | 114.6 | 70 | 71.5 | 83.1 | 26.3 | 28.6 | 25.1 | 27.2 |
| Viscosity after 1 day | 81.5 | 139.2 | 156.5 | 192 | 39.8 | 61.3 | 78.5 | 56.6 | 109 | 130.5 | 210 | 8300* | 24.9 | 27.6 | 36.4 | 41.7 |
| Viscosity after 3 days | 96.6 | 120.3 | 180.8 | 213 | 46.1 | 70.9 | 69 | 85 | 120.3 | 152 | 153.5 | 6250* | 37.1 | 33.8 | 36.2 | 39.8 |
| Viscosity after 8 days | 84.3 | 135.8 | 203 | 276.6 | 54.1 | 73.8 | 82.4 | 90.9 | 105.2 | 157 | 103.7 | 410 | 35.9 | 35.8 | 37.1 | 39.9 |
| Viscosity after 14 days | 122.1 | 146.7 | 225.7 | 373 | 43.1 | 119.5 | 69.8 | 248 | 78 | 245 | 122.8 | 235.2 | 28.8 | 25.2 | 26.5 | 28.2 |
| Viscosity after 21 days | 94.5 | 132.3 | 177.6 | 354 | 35 | 32.5 | 67.5 | 187.5 | 108.9 | 131.5 | 159.7 | 243 | 48.2 | 34.7 | 38.1 | 41.5 |

*Report of viscosity measured believed to be a typographical error since repeat of this experiment did not exhibit a similar spike in viscosity.

### Example 2

Formulations 2A-2H were prepared using the ingredients and amounts (in grams) listed in Table 4. To prepare the component 1, the polymeric dispersion was added into a small mixing container. A mixer was added and the dispersion was mixed under low shear conditions. In another container, the other ingredients of component 1 were pre-mixed. This mixture was then added slowly into the polymeric dispersion to form component 1. Component 1 was mixed until homogeneous (˜20 minutes under low shear conditions). Once component 1 was thoroughly mixed, component 2 (where used) was added and stirred in with a paint stick by hand for several minutes. Upon completion of the mixing, the formulation was ready for application and testing.

TABLE 4

| | | | | | | | | |
|---|---|---|---|---|---|---|---|---|
| Example | 2A | 2B | 2C | 2D | 2E | 2F | 2G | 2H |

Component 1

| | | | | | | | | |
|---|---|---|---|---|---|---|---|---|
| Bayhydrol ® A 2546⁹ | — | — | — | — | — | — | — | 34.69 |
| Bayhydrol ® UH 2557⁴ | — | — | — | — | 75.63 | 72.34 | 71.14 | — |
| Bayhydrol ® UH 2558⁶ | 74.08 | 59.26 | 70.93 | 69.83 | — | — | — | — |
| Baysilone ® 3468¹⁰ | — | — | — | — | — | — | — | 0.31 |
| Deionized water | 4.08 | 4.08 | 3.91 | 3.85 | 3.84 | 3.67 | 3.61 | 9.37 |
| Butyl CARBITOL ™² | 2.44 | 2.44 | 2.34 | 2.30 | 2.29 | 2.19 | 2.16 | — |
| DSX ® 1514¹¹ | — | — | — | — | — | — | — | 2.22 |
| DOWANOL ™ DPnB¹² | 1.64 | 1.64 | 1.57 | 1.55 | 1.54 | 1.47 | 1.45 | — |
| TEGO ® Foamex 822¹³ | — | — | — | — | — | — | — | 0.14 |
| BYK ®-346¹⁴ | 0.2 | 0.2 | 0.19 | 0.19 | 0.19 | 0.18 | 0.18 | — |
| Disperbyk ® 2015¹⁵ | 0.84 | 0.84 | 0.8 | 0.79 | 0.79 | 0.76 | 0.74 | 0.62 |
| TINT-AYD ® CW 5003¹⁶ | 16.72 | 16.73 | 16.01 | 17.72 | 15.72 | 15.04 | 16.98 | 21.85 |
| Bayhydrol ® A 2646¹⁷ | — | — | — | — | — | — | — | 14.87 |
| Dispercoll ® U KA 8755¹⁸ | — | 14.81 | — | — | — | — | — | — |

Component 2

| | | | | | | | | |
|---|---|---|---|---|---|---|---|---|
| Bayhydrol ® XP 2655¹⁹ | — | — | — | 3.77 | — | — | 3.75 | — |
| Desmodur ® XP 2802⁸ | — | — | 4.25 | — | — | 4.35 | — | — |
| Bayhydur ® XP 2547²⁰ | — | — | — | — | — | — | — | 15.92 |

⁹Anionic Polyacrylate Dispersion, Bayer MaterialScience LLC
¹⁰Modified polysiloxane flow, leveling and slip additive, OMG Borchers GmbH
¹¹Rheology-additive, BASF Corporation
¹²Dipropylene Glycol n-Butyl Ether, The Dow Chemical Company
¹³Defoamer emulsion, Evonik Industries AG
¹⁴Silicone surfactant, BYK USA Inc.
¹⁵Wetting and dispersing additive, BYK USA Inc.
¹⁶Pigment dispersion, Elementis Specialties, Inc.
¹⁷Aqueous Hydroxy-Functional Polyacrylic Dispersion, Bayer MaterialScience LLC
¹⁸An aqueous anionic dispersion of a high molecular weight polyurethane, Bayer MaterialScience LLC
¹⁹Hydrophilic Aliphatic Polyisocyanate based on hexamethylene diisocyanate (HDI), Bayer MaterialScience LLC
²⁰Water-dispersible polyisocyanate based on HDI, average equivalent weight of 182, Bayer MaterialScience LLC

Each of formulations 2A-2H were sprayed on a vinyl lineal. The vinyl was cleaned with an isopropal wipe and lightly sanded with a general purpose ScotchBrite pad prior to application of the coating. The dry film thickness of the coating was 2 mils (50.8 μm) and the samples were allowed to age at 23° C. and 50% relative humidity for a period of 1 week prior to testing. The coatings were tested for dry adhesion, wet adhesion, and boiling water adhesion as described in AAMA 614 and 615 using two different ASTM standards, D 3330 and D 3359. ASTM D 3330 measures adhesion of the coating to the substrate after an “X” is cut into the surface of the coating. ASTM D 3359 makes 11 parallel cuts into the surface. 11 similar cuts are made at a 90° angle, crossing the first set. After tape is applied to the surface the adhesion can be characterized. Results are set forth in Table 5. “Passed” means that there was no removal of the coating film under the tape within or outside of the cross-hatched area or blistering anywhere on the test panel.

TABLE 5

| Example | Dry adhesion | Wet Adhesion | Boiling water adhesion |
|---|---|---|---|
| 2A | Passed | Passed | Passed |
| 2B | Passed | Passed | Passed |
| 2C | Passed | Passed | Passed |
| 2D | Passed | Passed | Passed |
| 2E | Failed | Failed | Failed |
| 2F | Passed | Passed | Passed |
| 2G | Passed | Passed | Passed |
| 2H | Passed | Passed | Passed |

One test prescribed by AAMA 614/615 that was known to be a challenging test to pass is the detergent resistance test. According to this test, a 3% (by weight) solution of cleaning chemicals in water was prepared by dissolving solid detergent chemicals into warm water. The solid detergent composition is set forth in Table 6.

TABLE 6

| Technical grade reagent | % by weight |
|---|---|
| Anhydrous Tetrasodium pyrophosphate | 53 |
| Anhydrous Sodium Sulfate | 19 |
| Anhydrous Sodium Metasilicate | 7 |
| Anhydrous Sodium Carbonate | 1 |
| Dodecylbenzenesulfonic acid, sodium salt, tech. 88% | 20 |

The coated vinyl substrates were immersed in the testing solution for 72 hours at 38° C. Upon completion of the exposure time the coating surface was examined and adhesion was tested. Results are set forth in Table 7. “Passed” means that the film maintained adhesion and was visually unaffected by the testing.

TABLE 7

| Example | Detergent resistance |
|---|---|
| 2A | Fail (Film cracked) |
| 2B | Fail (Film cracked) |
| 2C | Fail (Film cracked) |
| 2D | Fail (Film cracked) |
| 2E | Fail (Film Deteriorated) |
| 2F | Passed |
| 2G | Passed |
| 2H | Passed |

### Example 3

Formulations 3A-3J were prepared using the ingredients and amounts (in grams) listed in Table 8. To prepare the component 1, the polyurethane dispersion was added into a small mixing container. A mixer was added and the polyurethane dispersion was mixed under low shear conditions. In another container, the water, butyl carbitol, Dowanol DPnB, BYK 346 and Disperbyk 2015 were pre-mixed. This mixture was then added slowly into the polyurethane dispersion to form component 1. Component 1 was mixed until homogeneous (˜20 minutes under low shear conditions). Once the clear formulation is made, pigment was added into some formulations to provide color. Once component 1 was thoroughly mixed, component 2 and mixed for several minutes. Upon completion of the mixing, the formulation was ready for application and testing.

TABLE 8

| | | | | |
|---|---|---|---|---|
| 3A | 3B | 3C | 3D | 3E |

Component 1

| | | | | | |
|---|---|---|---|---|---|
| Bayhydrol ® UH 2557⁴ | 1076.9 | 1055.35 | 1033.83 | 1012.28 | 990.76 |
| Deionized Water | 54.58 | 53.49 | 52.39 | 51.3 | 50.2 |
| Butyl CARBITOL ™² | 32.63 | 31.98 | 31.32 | 30.67 | 30.02 |
| DOWANOL ™ DPnB¹² | 21.95 | 21.51 | 21.08 | 20.62 | 20.19 |
| BYK ®-346¹⁴ | 2.66 | 2.61 | 2.56 | 2.52 | 2.46 |
| Disperbyk ® 2015¹⁵ | 11.28 | 11.05 | 10.82 | 10.6 | 10.37 |
| TINT-AYD ® CW 500316 | — | — | — | — | — |

Component 2

| Desmodur ® XP 2802⁸ | — | 24 | 48 | 68 | 89 |
|---|---|---|---|---|---|
| | 3F | 3G | 3H | 3I | 3J |

Component 1

| | | | | | |
|---|---|---|---|---|---|
| Bayhydrol ® UH 2557⁴ | 907.62 | 889.47 | 871.32 | 853.17 | 835.02 |
| Deionized Water | 46 | 45.08 | 44.16 | 43.24 | 42.31 |
| Butyl CARBITOL ™² | 27.5 | 26.95 | 26.4 | 25.85 | 25.3 |
| DOWANOL ™ DPnB¹² | 18.5 | 18.13 | 17.76 | 17.39 | 17.02 |
| BYK ®-346¹⁴ | 2.24 | 2.2 | 2.16 | 2.12 | 2.08 |
| Disperbyk ® 2015¹⁵ | 9.5 | 9.31 | 9.12 | 8.93 | 8.74 |
| TINT-AYD ® CW 500316 | 188.63 | 184.86 | 181.08 | 177.31 | 173.54 |

Component 2

| | | | | | |
|---|---|---|---|---|---|
| Desmodur ® XP 2802⁸ | — | 24 | 48 | 68 | 89 |

Samples for storage were poured off from the large initial batch into 2 oz (59.1 milliliter) jars. The jars were then sealed and placed in a storage location. One set of samples were placed in a 50° C. oven and another set of samples were left at room temperature (22.2° C.). Bi-Weekly for up to 16 weeks the jars were unsealed and compared to the original results for viscosity and gloss. Gloss measurements were made by drawing down the stored paint at 5 mils wet film thickness. The coating was then allowed to cure at 23° C. and 50% relative humidity for 1-week prior to analysis. Viscosity values, in cPs, were obtained as described in Example 1. Gloss readings were made using a BKY Micro-Tri-Gloss meter at a 60° angle. Results are set forth in Table 9.

TABLE 9

| | Initial | 2-Week | 4-Week | 6-Week | 8-Week |
|---|---|---|---|---|---|
| Storage Stability (50° C.) | viscosity | viscosity | viscosity | viscosity | viscosity |
| 3A | 79.6 | 26.8 | 42.2 | 73.5 | 77.1 |
| 3B | 28.1 | 45.4 | 36.8 | 29.7 | 28.8 |
| 3C | 31.8 | 29.5 | 39.6 | 45 | 44.4 |
| 3D | 41.5 | 57.8 | 96.3 | 194.1 | 226.8 |
| 3E | 31.9 | 13920 | GELLED | GELLED | GELLED |
| 3F | 30.2 | 36.9 | 21.5 | 27.3 | — |
| 3G | 21.9 | 33.3 | 27.2 | 33.9 | — |
| 3H | 41.3 | 35.4 | 47.5 | 48.3 | — |
| 3I | 27.6 | 209.2 | 238 | 228 | — |
| 3J | 54.1 | PASTE | GELLED | GELLED | — |
| Storage Stability (Room | Initial | 2-Week | 4-Week | 6-Week | 8-Week |
| Temperature) | Viscosity | Viscosity | Viscosity | Viscosity | Viscosity |
| 3A | 79.6 | 24 | 29 | 25.2 | 27 |
| 3B | 28.1 | 32.4 | 26.5 | 24.6 | 31.5 |
| 3C | 31.8 | 25.9 | 29.1 | 28.2 | 51.6 |
| 3D | 41.5 | 35.7 | 25.6 | 62.1 | 37.5 |
| 3E | 31.9 | 34.2 | 41.6 | 67.5 | 69 |
| 3F | 30.2 | 83.2 | 21.4 | 28.5 | — |
| 3G | 21.9 | 29.5 | 28.9 | 31.5 | — |
| 3H | 41.3 | 17.5 | 29.6 | 34.2 | — |
| 3I | 27.6 | 27.3 | 37.2 | 39.3 | — |
| 3J | 54.1 | 41.6 | 44.3 | 64.8 | — |

| | 60° Gloss | | | |
|---|---|---|---|---|
| Storage (50° C.) | Initial | 2-Weeks | 4-Weeks | 6-Weeks |
| 3A | 89.4 | N/A | 90.7 | 90.2 |
| 3B | 91.5 | 91.6 | 91.1 | 90.9 |
| 3C | 91.2 | 91.5 | 89.6 | 90.7 |
| 3D | 91.6 | 91.1 | 90.4 | 90.4 |
| 3E | 91.3 | 90.1 | Gelled | Gelled |
| 3F | 40.5 | 52 | 48.1 | 10 |
| 3G | 55.1 | 67 | 59.8 | 56.9 |
| 3H | 61.1 | 75 | 63.5 | 56.1 |
| 3I | 67.6 | 69.5 | 52.3 | 58.4 |
| 3J | 75.4 | Gelled | Gelled | Gelled |

| | 60° Gloss | | | |
|---|---|---|---|---|
| Storage (Room Temperature) | Initial | 2- Weeks | 4-Weeks | 6-Weeks |
| 3A | 89.4 | 91 | 90.6 | 90.9 |
| 3B | 91.5 | 91.2 | 86.4 | 90.5 |
| 3C | 91.2 | 91 | 90.8 | 91.1 |
| 3D | 91.6 | 91.4 | 91.1 | 91.3 |
| 3E | 91.3 | 91.2 | 91.5 | 91.3 |
| 3F | 40.5 | 44.5 | 49.7 | 62 |
| 3G | 55.1 | 53.9 | 59.6 | 62.4 |
| 3H | 61.1 | 60.9 | 65.4 | 55.1 |
| 3I | 67.6 | 73.3 | 70.3 | 67.5 |
| 3J | 75.4 | 74.2 | 74.9 | 65.2 |

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth herein. Such embodiments may be obtained, for example, by combining, modifying, or reorganizing any of the disclosed steps, components, elements, features, aspects, characteristics, limitations, and the like, of the various non-limiting embodiments described in this specification. In this manner, Applicant(s) reserve the right to amend the claims during prosecution to add features as variously described in this specification, and such amendments comply with the requirements of 35 U.S.C. §112, first paragraph, and 35 U.S.C. §132(a).

What is claimed is:

1. A coating composition comprising:
(A) an aqueous dispersion comprising:
(i) an aliphatic, fatty-acid containing, anionic polyurethane; and
(ii) an acid-reactive crosslinking agent comprising a compound comprising epoxy, carbodiimide, aziridine and/or oxazoline groups, and
(B) a coalescing agent having an evaporation rate of less than 0.8 (n-butyl acetate=1.0) that is present in an amount of at least 2 percent by weight, based on the total weight of the coating composition.

2. The coating composition of claim 1, wherein the coating composition has a pot-life of at least 1 month.

3. The coating composition of claim 1, wherein (A)(i) has a minimum film forming temperature of at least 30° C.

4. The coating composition of claim 1, wherein the polyurethane is a reaction product of reactants comprising:
(1) a polyisocyanate;
(2) at least two polymeric polyols having a number average molecular weight of 500 to 6000 and comprising:
(a) a fatty-acid containing polyester polyol; and
(b) a polytetramethylene ether glycol;
(3) a compound comprising at least one isocyanate-reactive group and an anionic group or potentially anionic group;
(4) a compound with a molecular weight below 500 g/mol and comprising a polyol, an aminopolyol and/or a polyamine; and
(5) a monoalcohol having a molecular weight of 32 to 145 g/mol and/or a monoamine having a molecular weight of 17 to 147 g/mol,
wherein each of reactants (1)-(5) is different from each other.

5. The coating composition of claim 4, wherein the polyurethane has a hard segment content of 40 to 60% by weight, based on the total weight of the polyurethane.

6. The coating composition of claim 4, wherein the polyurethane has a calculated amine content of no more than 0.1% of NH equivalents, based on total weight of resin solids.

7. The coating composition of claim 1, wherein the fatty-acid containing polyester polyol is a transesterification product of castor oil and one or more oils with an iodine number of greater than 100 g I₂/100 g of substance.

8. The coating composition of claim 7, wherein the one or more oils with an iodine number of greater than 100 g I₂/100 g of substance comprises soy bean oil.

9. The coating composition of claim 8, wherein the castor oil is used in an amount of 50 to 70 percent by weight and the soy bean oil is used in an amount of 30 to 50 percent by weight, the weight percents being based on the total weight of the reactants used to make the polyester polyol.

10. The coating composition of claim 1, wherein component (2)(a) is used in an amount of at least 40% by weight and 110 more than 50% by weight, based on the total weight of component (2) and component (2)(b) is used in an amount of at least at least 50% by weight and no more than 60% by weight, based on the total weight of component (2).

11. The coating composition of claim 4, wherein component (4) comprises a polyol and a polyamine, wherein
(a) the polyol comprises a diol that is present in an amount of at least 50% by weight and/or no more than 70% by weight, based on the total weight of component (4), and
(b) the polyamine comprises a diamine and a triamine, wherein the diamine is present in an amount of at least 20% by weight and no more than 50% by weight, based on the total weight of component (4), and the triamine is present in an amount of at least 5% by weight and no more than 10% by weight, based on the total weight of component (4).

12. The coating composition of claim 1, wherein the crosslinking agent comprises a polycarbodiimide that is a condensation reaction product of a polyisocyanate in the presence of a suitable catalyst, wherein the polyisocyanate comprises an aliphatic polyisocyanate comprising 4,4′-dicyclohexylmethane diisocyanate.

13. The coating composition of claim 1, wherein the coating composition comprises a mixture of:
(a) an aqueous aliphatic, fatty-acid containing, anionic polyurethane dispersion present in an amount of at least 70% by weight and up to 98% by weight, based on the total weight of the coating composition; and
(b) an acid-reactive crosslinking agent comprising an aqueous aliphatic polycarbodiimide dispersion present in an amount of greater than 2% up to 10% by weight, based on the total weight of the coating composition.

14. The coating composition of claim 1, wherein the coalescing agent, has an evaporation rate of less than 0.01 relative to n-butyl acetate (n-butyl acetate=1.0).

15. The coating composition of claim 14, wherein the coalescing agent is completely miscible in water.

16. A method of using the coating composition of claim 1, comprising applying the coating composition to a surface comprising a polyvinyl material comprising polyvinyl chloride.

17. An article having a coating deposited thereon, wherein the coating is deposited from the coating composition of claim 1 and wherein the article is a frame of an architectural article.

18. The article of claim 17, wherein the coating passes the dry adhesion and boiling water adhesion tests described in AAMA 615-05, section 6.4 and the detergent resistance test described in AAMA 615-05, section 6.7.4.

19. A coating composition comprising:
(A) an aqueous dispersion comprising:
(i) an aliphatic, fatty-acid containing, anionic polyurethane polyurethane having a hard segment content of 40 to 60% by weight, based on the total weight of the polyurethane, and comprising a reaction product of reactants comprising:
(1) a polyisocyanate;
(2) at least two polymeric polyols having a number average molecular weight of 500 to 6000 and comprising:
(a) a fatty-acid containing polyester polyol that is a transesterification product of castor oil and soy bean oil; and
(b) a polytetramethylene ether glycol;
(3) a compound comprising at least one isocyanate-reactive group and an anionic group or potentially anionic group;
(4) a compound with a molecular weight below 500 g/mol and comprising a polyol, an aminopolyol and/or a polyamine; and
(5) a monoalcohol having a molecular weight of 32 to 145 g/mol and/or a monoamine having a molecular weight of 17 to 147 g/mol;
wherein each of reactants (1)-(5) is different from each other; and
(ii) an acid-reactive crosslinking agent comprising a compound comprising epoxy, carbodiimide, aziridine and/or oxazoline groups, and
(B) a coalescing agent having an evaporation rate of less than 0.8 (n-butyl acetate=1.0) that is present in an amount of at least 2 percent by weight, based on the total weight of the coating composition,
wherein the coating composition has a pot-life of at least 1 month.

20. The coating composition of claim 19, wherein (A)(i) has a minimum film forming temperature of at least 30° C.

21. The coating composition of claim 19, wherein component (2)(a) is used in an amount of at least 40% by weight and no more than 50% by weight, based on the total weight of component (2) and component (2)(b) is used in an amount of at least at least 50% by weight and no more than 60% by weight, based on the total weight of component (2).

22. The coating composition of claim 19, wherein component (4) comprises a polyol and a polyamine, wherein
(i) the polyol composes a diol that is present in an amount of at least 50% by weight and/or no more than 70% by weight, based on the total weight of component (4), and
(ii) the polyamine comprises a diamine and a triamine, wherein the diamine is present in an amount of at least 20% by weight and no more than 50% by weight, based on the total weight of component (4), and the triamine is present in an amount of at least 5% by weight and no more than 10% by weight, based on the total weight of component (4).

23. The coating composition of claim 19, wherein the coating composition comprises a mixture of:
(a) an aqueous aliphatic, fatty-acid containing, anionic polyurethane dispersion present in an amount of at least 70% by weight and up to 98% by weight, based on the total weight of the coating composition; and
(b) an acid-reactive crosslinking agent comprising an aqueous aliphatic polycarbodiimide dispersion present in an amount of greater than 2% up to 10% by weight, based on the total weight of the coating composition.

24. The coating composition of claim 19, wherein the crosslinking agent comprises a polycarbodiimide comprising a condensation reaction product of a polyisocyanate in the presence of a suitable catalyst, wherein the polyisocyanate comprises an aliphatic polyisocyanate comprising 4,4′-dicyclohexylmethane diisocyanate.

25. The coating composition of claim 19, wherein the coalescing agent, has an evaporation rate of less than 0.01 relative to n-butyl acetate (n-butyl acetate=1.0).

26. A method of using the coating composition of claim 19, comprising applying the coating composition to a surface comprising a polyvinyl material comprising polyvinyl chloride.

27. An article having a coating deposited thereon, wherein the coating is deposited from the coating composition of claim 19 and wherein the article is a frame of an architectural article.

28. The article of claim 27, wherein the coating passes the dry adhesion and boiling water adhesion tests described in AAMA 615-05, section 6.4 and the detergent resistance test described in AAMA 615-05, section 6.7.4.
